(19) United States
(12) Patent Application Publication
(10) Pub. No.: US 2013/0139465 A1
(43) Pub. Date: Jun. 6, 2013

(54) Deck bracket

(71) Applicants: Gerry D. Kuryk, St Thomas (CA); Scott J. Dickson, Thamesford (CA)

(72) Inventors: Gerry D. Kuryk, St Thomas (CA); Scott J. Dickson, Thamesford (CA)

(21) Appl. No.: 13/309,615

(22) Filed: Dec. 2, 2011

(51) Int. Cl. E04B 1/38; F16B 1/00

(52) U.S. Cl. 52/655.1; 248/205.1

(57) ABSTRACT

There is disclosed a bracket for connecting an unsecured element to a secured element, the bracket comprising an attachment face for connecting the bracket to the unsecured element, one or more flanges for connecting the bracket to the secured element and one or more lateral supports, connecting the attachment face to the one or more flanges, wherein at least one lateral support creates at least one non-right angles between the lateral support and the attachment face or the lateral support and the flanges. The bracket may allow, for example, decks to be attached to houses and effectively resist vertical and lateral forces.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

There is considerable construction-industry experience in attaching objects together in a way that prevents various types of motion. More specifically, attaching unsecured structural elements (such as decks, staircases, and the like) to secured elements (such as foundations, house frames and other fixed building elements) has been known for some time.

However, ways to attach unsecured elements to secured elements, and attaching decks to houses in particular, have not been adequately developed. Conventional approaches often lack adequate lateral strength while maintaining suitable dimensions, ease and flexibility of installation, and material properties.

The present invention therefore seeks to address some of the shortcomings in the field.

### FIELD OF THE INVENTION

The present invention relates to an apparatus for attaching an unsecured structural element to a secured structural element and in particular, in one embodiment, to an apparatus for attaching a deck to a house.

### SUMMARY OF THE INVENTION

It is an object of the present invention to address the problems noted hereinabove, particularly, as they relate to an effective deck bracket.

Accordingly, the invention provides in one aspect a deck bracket comprising a bracket body, further comprising an attachment face that is substantially parallel to a deck section and enables connecting the deck bracket to the deck section, and two lateral supports located on either side of the attachment face and extending towards the outer flanges, and two outer flanges, one attached to each of the two lateral supports, that are substantially parallel to the building section and enable connecting the deck bracket to the building section.

The lateral supports may extend from the attachment face at an obtuse angle and the lateral supports extend from the outer flanges at an obtuse angle.

The width of the deck bracket may be the width of a piece of veneer. The perpendicular distance between the outer flanges and the attachment face may allow the attachment face to extend a determined distance past the house's veneer. The attachment face and the outer flanges may have one or more bores for bolts to pass through so as to enable connection of the deck bracket to the deck section and building section respectively.

In a further aspect the invention provides a bracket for connecting an unsecured element to a secured element, the bracket comprising an attachment face for connecting the bracket to the unsecured element, one or more flanges for connecting the bracket to the secured element, and one or more lateral supports, connecting the attachment face to the one or more flanges, wherein at least one lateral support creates at least one non-right angles between the lateral support and the attachment face or the lateral support and the flanges.

In yet a further aspect there is a bracket for connecting an unsecured element to a secured element, the bracket comprising a bracket body, that is substantially U-shaped, with an attachment face at the bottom of the U that is connectable to the unsecured element and one or more outer flanges, connected to the bracket body near the top of the U, and connectable to the secured element.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a perspective view of an embodiment of a deck bracket according to the invention;

FIGS. 2A-E are orthogonal views, from the side, of embodiments of a deck bracket according to the invention;

FIG. 3 is an orthogonal view, from above, of an embodiment of a deck bracket and external deck bracket installation according to the invention; and

FIG. 4 is an orthogonal view, from above, of an embodiment of a deck bracket and internal deck bracket installation according to the invention.

### DETAILED DESCRIPTION OF PREFERRED EMBODIMENTS

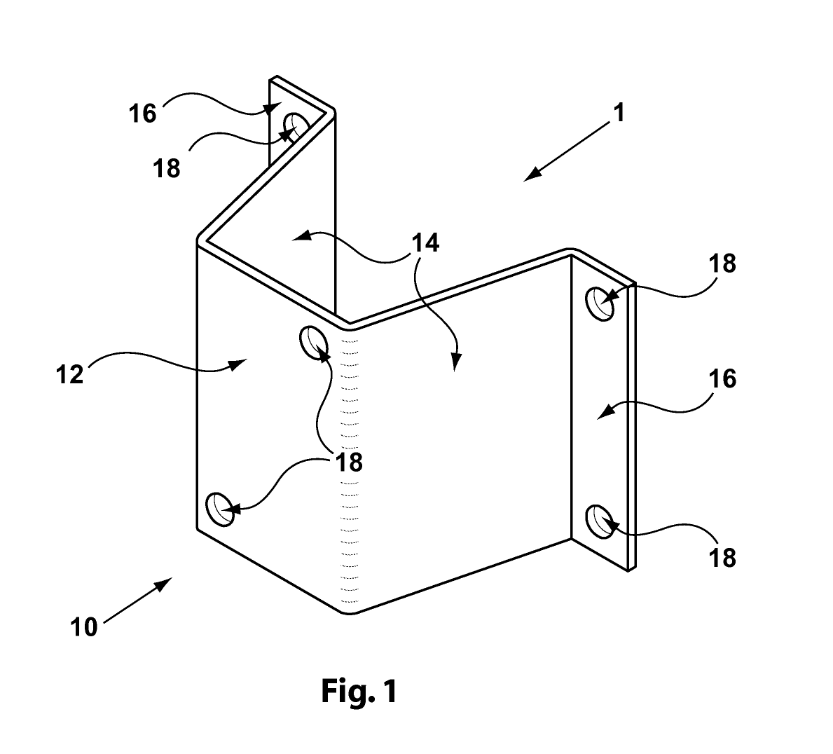

FIG. 1 is perspective view of an embodiment of deck bracket 1 (or bracket 1) according to the invention. Deck bracket 1 comprises bracket body 10 which further comprises attachment face 12 which may further comprise one or more bores 18, and lateral supports 14. Deck bracket further comprises outer flanges 16 which each may further comprise one or more bores 18.

Deck bracket 1 may be used to connect deck section 150 102, or other unsecured elements 150, to building section 114, or other secured elements 110. One side of deck bracket 1 may be connected to deck section 102 (either the outer flanges 16 side or preferably the attachment face 12 side) and the other side of deck bracket 1 may be connected to building section 114 (preferably the outer flanges 16 side). Such connections may be via bolts that extend through bores that are either inserted into building section 114 or deck section 152 or are fixed thereto, for example via bolts. Deck bracket 1 and the connections to deck section 152 and building section 114 may substantially prevent any movement of deck section 152 with respect to building section 114—either rotation or translation.

Importantly, one or more deck brackets 1 may withstand all forces acting on it by forces acting on a deck or similar surface, such as may be transmitted to deck bracket 1 via deck section 152. Such forces may include vertical forces (which may include the weight of the deck and any objects on the deck), lateral forces (as described herein but that may include the force of objects moving horizontally along the deck, such as a person walking or running across the deck parallel to the plane of attachment face 12). Both lateral and vertical forces may be unidirectional (ie: just left to right lateral forces and not right to left, or just downwards forces) or may typically be bi-directional, at least for lateral forces. In withstanding such forces, deck bracket 1 must not itself deform or move, or allow deformation or movement of either of building section 114 or deck section 152.

The overall shape and orientation of deck bracket 1, and bracket body 10 in particular, which may be described as “U”-shaped and rotated so that a “U”-shaped cylinder would extend vertically (with outer flanges 16 located at the top of the “U” shape), exhibits desirable strength and resistance characteristics. In particular deck bracket 1 is strong with respect to vertical forces and lateral forces (both as described herein).

Dimensions of deck bracket 1 may be chosen to achieve various objectives, as further described herein. The following objectives provide illustrative examples:
(a) The overall width of deck bracket 1 may be chosen to conform or relate to the size of a brick or piece of veneer 156 on a house, the distance between building elements such as floor joists or truss sections, or locations on building section 114 where outer flanges 16 are going to attach. Preferably the overall width of deck bracket 1 will remain the same and will be suitable for all desired uses.
(b) The overall height of deck bracket 1 may be chosen to conform or relate to the height of a brick or siding panel of veneer 156 of a house (for example being the height of one or two brick's height). Alternatively the height may be chosen to conform or relate to the height of deck section 152. For example, if deck section 152 is one or more 2″×8″, the height of deck bracket 1 may be 8″, somewhat less than 8″ to allow some flexibility in attaching, or may be somewhat more than 8″. It should be noted that although deck bracket 1 may be of uniform height this is not required and the height may vary at different points of deck bracket 1, if required or desired.
(c) The depth of deck bracket may be chosen to conform or relate to the depth of a brick veneer of a house.
(d) Any of the above dimensions, and others such as thickness, may also be determined to achieve strength, ease of installation, and other objectives.

Deck bracket 1 may be made of substantially any material, as determined by the desired functionality of deck bracket 1. Functionality may include strength, weight, resistance to rust, suitability for combining with wood (both pressure-treated and non pressure-treated), color, dimensions, etc. Exemplary materials may include steel, galvanized steel, plastic, aluminum, other materials, or combinations thereof (including coating one or more materials in another one or more materials). In one preferred embodiment, deck bracket 1 may be made of galvanized steel, which can be used with a multitude of deck section 152 and building section 114 materials.

Outer flanges 16, lateral supports 14 and attachment face 12 (substantially all of deck bracket 1) may be shaped from a solitary member or may be one or more members shaped and fit together.

Attachment face 12 may be of suitable size to connect to deck section 152, and bores 18 thereon may be located with similar considerations in mind. Attachment face 12 may be substantially parallel to at least the part of deck section 152 to which it is attached, and may also be substantially parallel to building section 114. In one example, attachment face 12 is parallel to the deck ledger board (deck section 152) and the house's wall.

Outer flanges 16 may be separate flanges, each attached to one or more lateral supports 14 but not to each other, or they may be integral (and possibly integral with the rest of deck bracket 1, as described herein) and span each lateral support 14. Outer flanges may be substantially parallel to at least the part of building section 114 to which it is attached, and may also be substantially parallel to deck section 152. In one example, attachment face 12 is parallel to the house's wall or veneer 156 and the deck ledger board (deck section 152).

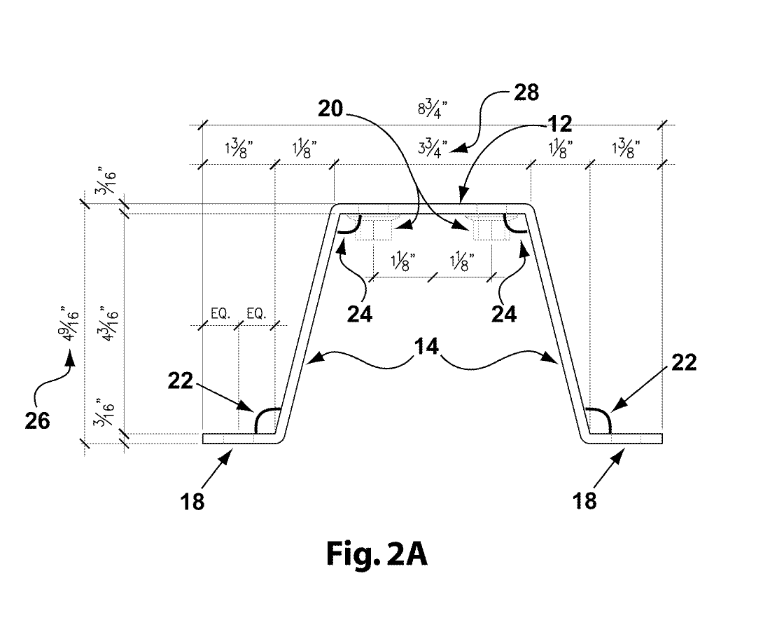

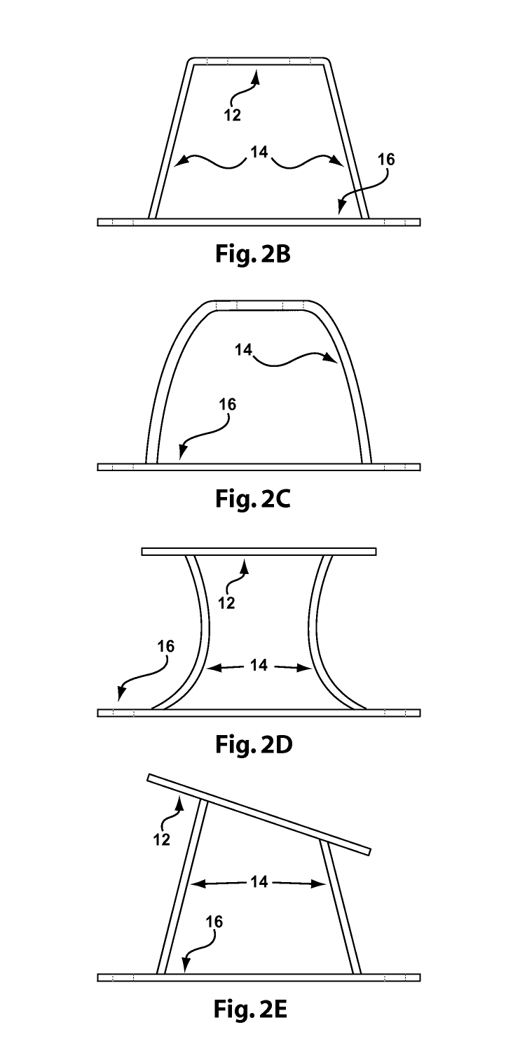

FIGS. 2A-E are orthogonal views, from the side, of embodiments of deck bracket 1 according to the invention.

The orthogonal view in FIG. 2A further comprises attachment face nut 20, flange angle 22, attachment face angle 24, and perpendicular depth 26. The orthogonal view in FIG. 2A also shows dimensions of one embodiment of deck bracket 1.

One or more attachment face nuts 20 may assist in connecting deck bracket 1 to deck section 102 (such as by connecting attachment face 12 to deck section 152). Attachment face nut 20 may be a nut that may allow a bolt to be inserted therein, after having gone through bore 18 on attachment face 12. Attachment face nut 20 is optional but may be desirable in preferred embodiments. Attachment face nut 20 may be integral to deck bracket 1, such as welded thereto, or may be separate therefrom.

Flange angle 22 and attachment face angle 24, as shown in FIG. 2, are formed by lateral support 14 meeting outer flanges 16 and attachment face 12 respectively. These angles created additional lateral strength for deck bracket 1. This additional lateral strength can be achieved by using one or more lateral supports (two as shown in FIG. 2) and selecting one or more angles for flange angle 22 and attachment face angle 24 (preferably non-right angles, as shown in FIG. 2).

Alternatively, bracket body 10 and/or lateral supports 14 may be substantially U-shaped, as described herein, with attachment face 12 being the bottom of the “U” (or connected to the bottom of the “U”) and outer flanges connected to or extending from a top, or tops, of the “U”. Such shaping may arguably eliminate flange angle 22 and attachment face angle 24 as the U becomes more circular. Such a configuration is within the scope of the present invention and also provides additional lateral strength, as is desirable. A U-shape may be achieved by two lateral supports 14 each being part of a “U” or by one integral lateral support 14 being the entire U and connecting to attachment face 12 and outer flanges 16 at one or more locations.

Flange angle 22 may be the smaller of the angles formed between outer flange 16 and lateral support 14, as shown. Flange angle 22 may be substantially any angle. However, in a preferred embodiment flange angle 22 may be any non-right, obtuse angle and may be 95-100 degrees or even 91-130 degrees. Flange angle 22 being obtuse will greatly increase the lateral strength of deck bracket 1.

Similarly, attachment face angle 24 may be the smaller of the angles formed between attachment face 12 and lateral support 14, as shown. Attachment face angle 24 may be substantially any angle. However, in a preferred embodiment attachment face angle 24 may be any non-right, obtuse angle and may be 95-100 degrees or even 91-130 degrees. Attachment face angle 24 being obtuse will greatly increase the lateral strength of deck bracket 1.

Perpendicular depth 26 may be the depth of deck bracket 1, measured perpendicularly from attachment face 12 plane to outer flanges 16 plane. Perpendicular depth 26 may be configured as needed but in one embodiment may be selected to make attachment face 12 flush with, or slightly extended from, a veneer of a house.

The simple orthogonal views in FIGS. 2B-E provide alternative embodiments of deck bracket 1, including embodiments with a single, but unified outer flange 16 (FIG. 2B), where attachment face 12 blends into lateral supports 14 (FIG. 2C), where lateral sections 14 are C-shaped and back to back, and where attachment face 12 is not parallel to outer flange 16 (FIG. 2E).

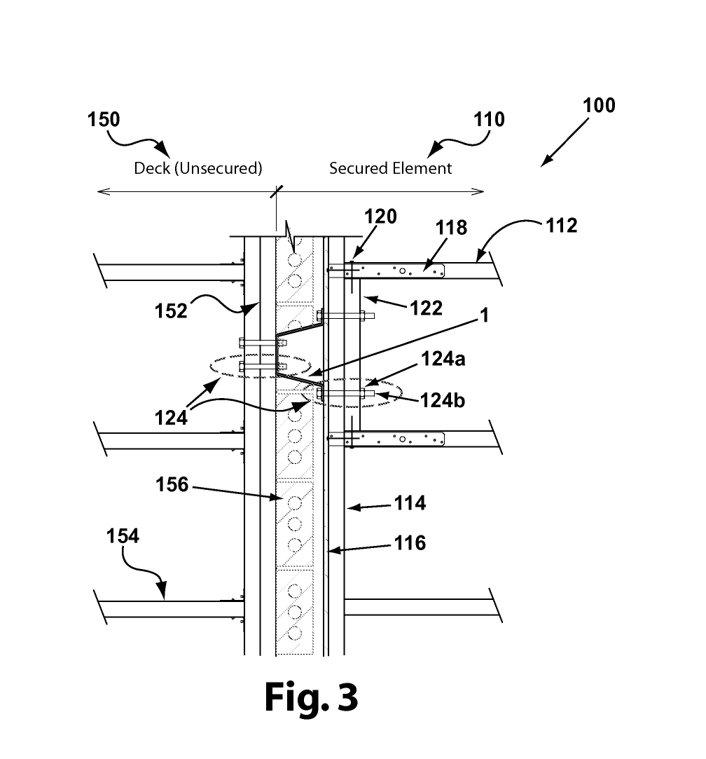

FIG. 3 is an orthogonal view, from above, of an embodiment of deck bracket 1 and external deck bracket installation 100 according to the invention. Deck bracket installation 100 (“DBI 100”) is one particular complete approach to connecting unsecured element 150 (such as a deck or deck section 152, which may be a joist or beam) to secured element 110 (such as a building or house). This overall connection requires essentially two connections: that of securing deck bracket 1 to secured element 110 and connecting unsecured element 150 to deck bracket 1.

It will be understood by those of skill in the art that DBI 100 can vary substantially while remaining within the scope of the present invention. By way of example, DBI 100 shown in FIG. 3A may conform to building codes in one or more jurisdictions but may require amendment to conform to other building codes. The particular configuration of secured element 110 may change (such as by house joists 112 being parallel to building section 114 as opposed to perpendicular thereto), and DBI 100 may then vary slightly, as would be known to someone of skill in the art. As a further example, DBI 100 may involve connecting to a concrete foundation of secured element 110, such as a concrete foundation of a house. In such instance DBI 100 may not involve nut 124a and bolt 124b may simply be drilled into, and supported by, the concrete.

Although many parts of a deck and a house are abstracted in FIG. 3A, DBI 100 in FIG. 3A is shown in substantially completed form. Both required connections are largely complete and other aspects of the deck (such as joists) and the house (such as the veneer) are in place. However, there are several approaches to arrive in such a position and all are considered within the scope of the present invention. For example, deck bracket 1 may be attached to secured element 110 (such as a house) during any stage of construction of the house—perhaps even before a deck or deck design is even considered. Deck bracket 1 may be connected to sheathing 116 and building section 114 even prior to veneer 156 being installed. Although veneer 156 may typically be installed prior to the deck being installed, this need not be the case. In a further example, deck bracket may be “retrofit”, meaning that it is largely installed after a house has been completed. This may be done by removing part of veneer 156, drilling through veneer 156, attaching to veneer 156 (for example if veneer 156 is load bearing and would support the requirements for a deck for example), attaching deck bracket 1 to a concrete foundation (not shown) that may or may not require excavation to access. Although it is expected that Connection 1 will generally occur before Connection 2, this need not be the case.

Connecting Deck Bracket to Secured Element (“Connection 1”)

As shown in FIG. 3 Connection 1 may further involve joists 112, building section 114, sheathing 116, strapping 118, nails 120, blocking 122, and connectors 124, which may further comprise nut 124a and bolt 124b.

As shown in FIG. 3, deck bracket 1, and outer flanges 16 in particular, are substantially flush with sheathing 112. Connectors 124 connect and attach outer flanges 16 to sheathing 116 by passing a bolt through bore 18, through sheathing 116, building section 114 and blocking 122 to finally insert through a nut and secure deck bracket 1 to secured element 150. Additionally, strapping 118, possibly in combination with plywood sheathing (not shown) may be connected, using nails 120 or other known approaches, to building section 114 and optionally joist 112 (which may be a joist, for example).

As discussed herein, Connection 1 may be done before Connection 2 and may be done before veneer 156 is in place. It is to be understood of course, that various approaches to securing Connection 1 (involving differences in secured element 110 and connectors 124) are within the scope of the present invention.

Connecting Unsecured Element to Deck Bracket (“Connection 2”)

Also as shown in FIG. 3 Connection 2 may further involve deck section 152, deck joist 154, veneer 156 and connectors 124, as described herein.

Attachment face 12 is substantially flush with deck section 152. Deck section 152, which may be, for example, two 2×8s, may have holes through them and arranged to match with bores 18 on attachment face. Connectors 124 may then establish the connection, with nut 124a (which may be attachment face nut 20) accepting bolt 124b that was passed through deck section 152, and bore 18.

Many alternatives for deck section 152 and connectors 124 are within the scope of the present invention, largely as would be known to those of skill in the art.

DBI 100 may be substantially any type of installation, including non-deck installations as described herein.

As used herein, building section 114 may include substantially any first surface that deck bracket 1 may be attaching to, via outer flanges 16 in particular. Building section 114 may be used somewhat interchangeably with secured element 110, and may thus be the structure that is largely already fixed and “secured”—such as a wall of a building or house.

In one embodiment building section 114 may be elements of a house, such as framing or wood rim board, concrete foundation, joists, exterior sheathing, or a combination thereof, and deck bracket 1 may be disposed on an external surface of building section 114 (such as external to a house wall) or sheathing 116 for such external surface. In a further embodiment, building section 114 may be disposed on an internal surface of building section 114 (such as internal to a house wall, near a stairwell for example).

As used herein, deck section 152 may include substantially any second surface that deck bracket 1 may be attaching to, via attachment face 12 in particular. Deck section 152 may be used somewhat interchangeably with unsecured element 150, and may thus be the structure that is not generally independently fixed and secured, like a deck or part of a staircase such as a landing.

In one embodiment deck section 152 may be elements of a deck, such as deck ledger board or other components of a deck that resides external to a house. In a further embodiment deck section 152 may be interior elements or a house that need to be connected to a house, such as staircases, staircase landings, and the like.

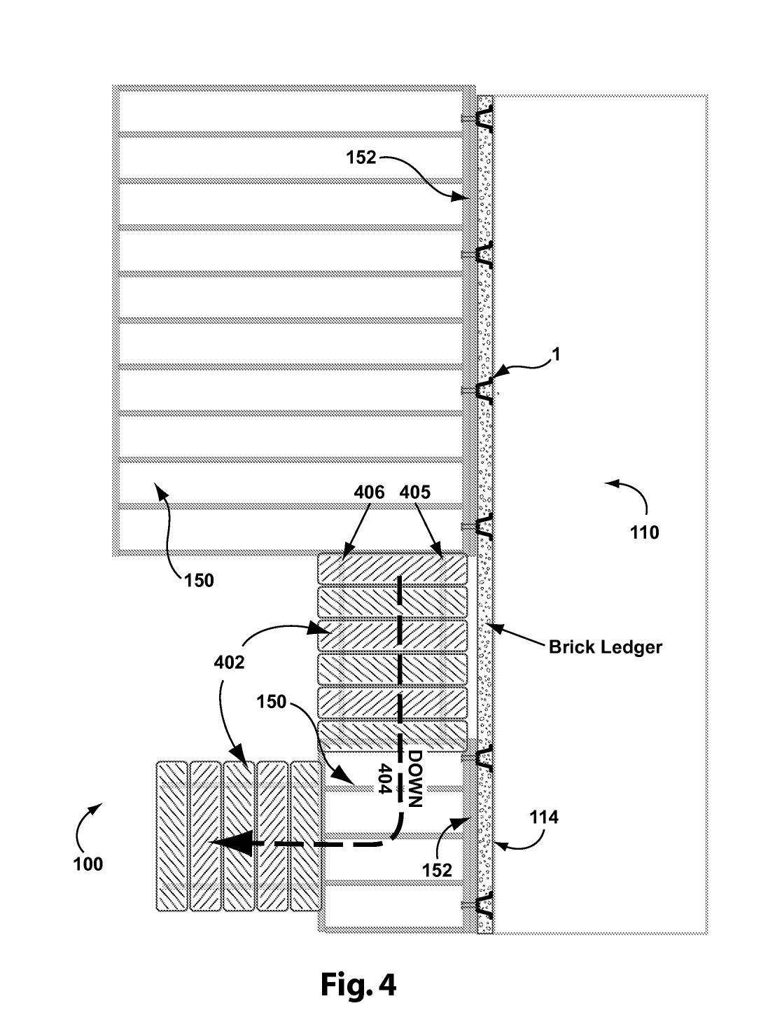

FIG. 4 is an orthogonal view, from above, of an embodiment of deck bracket 1 and DBI 100 according to the invention and may further comprise one or more staircases 402 and descending path 404.

DBI 100 shown in FIG. 4 is an example of an internal installation, where Connection 1 is with an inside surface of building section 114. Connection 2 may be with staircase 402 (which may further comprise left string 405 and right stringer 406), unsecured element 150 (which is a staircase landing in FIG. 4 and could also be a stringer for example), or the like, for example via deck section 152.

Alternatively, and still with respect to FIG. 4, stairs 402 (such as those next to the Brick Ledger, which may be an example of veneer 156) could be attached directly to the house. In such an embodiment, left stringer 405 could be connected to deck bracket 1 (Connection 2) and deck bracket 1 could be connected to building section 114, which may be an inside surface of the foundation (Connection 1). Right stringer 406 could then be fixed to a post that is cemented into the ground.

DBI 100 in FIG. 4 may be substantially similar in approach to DBI 100 in FIG. 3 and may provide many of the same advantages, as described herein. One advantage that is desirably maintained is deck bracket 1 having good lateral strength—in this case resistant to lateral shifting as someone descends staircase 402 along descending path 404, or ascends staircase 402 in the opposite direction.

DBI 100 in FIGS. 3 and 4 may involve further support for unsecured element 150 such as a deck and staircase 402 respectively, such as one or more vertical columns or posts (not shown), concrete footings, and the like (not shown). Such will depend, for example, on other design aspects of the particular unsecured element 150.

Essentially bracket 1 can be used to attach any portion or component of a deck, a fence, a gate, a trellis, or any other unsecured structural building element that is within the engineering specifications of size and distance from the building or secured element.

It will be apparent to one of skill in the art that other configurations of the various physical components, modules, methods and hardware may be used in any of the foregoing embodiments of the products, methods, and systems of this invention. It will be further understood that the specification is illustrative of the present invention and that other embodiments within the spirit and scope of the invention will suggest themselves to those skilled in the art.

1. A deck bracket comprising:
a bracket body, further comprising:
an attachment face that, in use, is substantially parallel to a vertical portion of a deck section and enables connecting the deck bracket to the vertical portion of the deck section, and
two lateral supports located on either side of the attachment face and extending from the attachment face; and
two outer flanges, one attached to each of the two lateral supports, that are substantially parallel to a building section and enable connecting the deck bracket to the building section.

2. The deck bracket of claim 1 wherein the two lateral supports extend from the attachment face at an obtuse angle.

3. The deck bracket of claim 1 wherein the two lateral supports extend from the outer flanges at an obtuse angle.

4. The deck bracket of claim 1 wherein the width of the deck bracket is the width of a piece of veneer.

5. The deck bracket of claim 1 wherein a perpendicular distance between the outer flanges and the attachment face allow the attachment face to extend a determined distance past a house's veneer.

6. The deck bracket of claim 1 wherein the attachment face and the outer flanges have one or more bores for bolts to pass through so as to enable connection of the deck bracket to the deck section and building section, respectively.

7. A bracket for connecting an unsecured element to a secured element, the bracket comprising:
an attachment face for connecting the bracket to the unsecured element, wherein, in use, the attachment face is parallel to a vertical portion of the unsecured element;
one or more flanges for connecting the bracket to the secured element; and
one or more lateral supports, connecting the attachment face to the one or more flanges, wherein at least one lateral supports creates at least one non-right angles between the lateral support and the attachment face or the lateral support and the flanges.

8. A bracket for connecting an unsecured element to a secured element, the bracket comprising:
a bracket body, that is substantially U-shaped, with an attachment at the bottom of the U that connects, in use, to a vertical portion of the unsecured element; and
one or more outer flanges, connected to the bracket body near the top of the U, and connectable to the secured element.

9. The bracket of claim 1, wherein the two outer flanges enable connecting the deck bracket to a vertical portion of the building section.

10. The bracket of claim 9, wherein the building section comprises a secured surface on a building, and the deck element comprises a staircase.

11. The bracket of claim 1, wherein the vertical portion comprises a side of the deck section having a surface perpendicular to the ground.

12. The bracket of claim 9, wherein the vertical portion of the building section comprises a surface of a wall of the building, the wall extending along a direction that is perpendicular to the ground.

13. The bracket of claim 1, wherein the two lateral supports extend outward toward the two outer flanges.

14. The bracket of claim 7, wherein the one or more outer flanges are connectable to a vertical portion of the secured element.

15. The bracket of claim 7, wherein the unsecured element comprises one or more of a deck, a fence, a gate, and a trellis.
